(19) United States
(12) Patent Application Publication
(10) Pub. No.: US 2011/0185278 A1
(43) Pub. Date: Jul. 28, 2011

(54) METHODS FOR PROVIDING A PLAYLIST BY ACQUIRING RADIO DATA SYSTEM INFORMATION FROM MULTIPLE RADIO STATIONS

(76) Inventors: Jason A. Flickinger, Santa Clara, CA (US); Justin Gregg, San Francisco, CA (US)

(21) Appl. No.: 12/693,360

(22) Filed: Jan. 25, 2010

(51) Int. Cl. G06F 3/16; H04M 1/00

(52) U.S. Cl. 715/727; 455/553.1

(57) ABSTRACT

Wireless electronic devices with two frequency modulation (FM) tuners are provided. An electronic device may use a first FM tuner to tune to a current radio station and may use a second FM tuner to scan other radio stations to obtain a list of radio data system (RDS) information. The electronic device may use the list of RDS information to display a master playlist that includes an alternate song list reflecting songs that are currently playing on the other radio stations. A user of the electronic device may select a song from the alternate song list, may switch to a new radio station to listen to the selected alternate song, may tag the song for later purchase, or may return to the master playlist. The user may purchase the tagged songs at a later time through a media management service that can be launched directly on the electronic device.

### BACKGROUND

This invention relates to radio systems, and more particularly, to gathering and processing radio channel information to support features such as recommended alternate radio station playlists.

Portable electronic devices such as handheld media players, mobile telephones, personal digital assistants, laptop computers, and other portable devices often include wireless communications circuitry. Wireless communications circuitry may include antennas, radio-frequency power amplifiers, and radio-frequency tuners that enable wireless electronic devices to tune to certain radio frequencies.

There are different types of radio broadcasting methods in use today. For example, wireless signals may be broadcast using a technique known as amplitude modulation (AM). Amplitude modulation refers to a mode of broadcasting radio-frequency signals that involves varying the amplitude of carrier signals in response to the strength of transmitted signals. Radio stations that broadcast signals in this way are referred to as AM radio stations.

Another broadcasting technique that is used involves broadcasting radio-frequency signals using a method known as frequency modulation (FM). Frequency modulation refers to a mode of transmitting wireless signals that involves varying the frequency of carrier signals in response of the strength of the transmitted signals. Radio stations that broadcast signals in this are referred to as FM radio stations. FM radio stations typically broadcast signals on very high frequency (VHF) airwaves. FM broadcasting frequencies can range from 76 MHz to 108 MHz.

A user may use a wireless electronic device with a radio tuner to listen to a radio station. The radio station may be playing a song. The radio station may be an FM radio station, as an example. The user may desire to listen to another song on another radio station. The user may therefore tune radio tuner in the electronic device to receive signals from a new radio station (e.g., by pressing a scan button instructing the electronic device to find the next available FM radio station). The new radio station may be playing a different song. The user may or may not want to listen to this new song. If the user does not want to listen to the new song, he may again scan to the next available radio station. The user may continue scanning all the available local radio stations in an effort to find a station playing a song he wants to listen to. Unfortunately, the user may only belatedly realize that the original song on the initial radio station was best. Because time was wasted during the scanning process, this original song may have been mostly missed by the user.

Manually scanning or stepping through all the available radio stations in this way may therefore be inefficient and cumbersome for the user. Even if a user has preset buttons providing shortcuts to certain preferred radio stations, the user would still need to step through the preset buttons to try to determine what songs each of the radio stations are currently playing.

It would therefore be desirable to be able to provide improved ways in which to provide a user of a radio device with information on currently available songs and other broadcast material.

### SUMMARY

This relates to portable wireless electronic devices. Wireless electronic devices may include storage and processing circuitry and input-output devices. The input-output devices may include buttons, a display (e.g., a touch screen), and wireless communications circuitry. The wireless communications circuitry may include antennas, frequency modulation (FM) radio tuners, and other circuitry.

The FM tuners may allow a wireless electronic device to selectively receive radio broadcasts from FM radio stations. The FM radio stations may broadcast audio information (e.g., songs). Every song may be broadcast with associated radio data system (RDS) information. RDS information may include information such as a station name, a station frequency, a station call identifier, an artist name, a song name, time remaining in the song, and a program type (song genre) associated with a given song playing on a given radio station.

The wireless electronic device may use a first FM tuner to tune to a radio station that the user is currently listening to. While the user is using the first tuner to listen to a given station, the electronic device may use a second FM tuner to scan the stations at other frequencies to obtain a list of RDS information from the other FM radio stations (e.g., to acquire a list of songs that are currently playing on the other radio stations). Using the list of RDS information, the device may display a list of alternate songs. If desired, the list of songs may be a subset of all of the songs that are currently playing on the other radio stations.

In a radio playlist mode, the wireless electronic device may display a master playlist. In displaying the master playlist, the display of the device may be divided into three regions. There may be a first region that displays information relating to the radio station to which the user is currently listening. There may be a second region that displays the list of alternate songs. Selected RDS information (e.g., only the station name, artist name, and song name) for the alternate songs may be displayed, if desired. There may be a third region that displays a list of similar songs. The similar songs may be songs that are already stored on the device and may be songs that belong to the same musical genre as the song playing on the current radio station. Information such as the artist name and the song name for the similar songs may be displayed in the third region, if desired.

The device may allow the user to select a song from the list of alternate songs. If the user selects an alternate song, a new screen may be displayed showing a complete list of RDS information. The user may also be provided with an opportunity to switch to the selected radio station (e.g., to listen to the selected alternate song) or an opportunity to tag the selected alternate song for later purchase. If the user is not interested in the selected alternate song, the user may return to the master playlist.

The user may also be provided with an option to adjust certain radio settings on the wireless electronic device. For example, the user may be able to limit the alternate song suggestion so that only songs of the same genre are displayed. The user may also be allowed to adjust display options that configure the device to display only a certain subset of the RDS information. The user may be able to adjust sorting options that display the songs on the master playlist in a particular order.

The user may access a media management service through the wireless electronic device or on a host computer that is connected to the device. The media management service may be an online service accessed over a wired or wireless network. The media management service may provide a list of previously tagged songs. The user may purchase and download songs from the list of previously tagged songs through the media management service.

Further features of the present invention, its nature and various advantages will be more apparent from the accompanying drawings and the following detailed description.

### BRIEF DESCRIPTION OF THE DRAWINGS

FIG. 1 is a perspective view of an illustrative wireless electronic device in accordance with an embodiment of the present invention.

FIG. 2 is a schematic diagram of an illustrative wireless electronic device that can be connected to associated equipment in accordance with an embodiment of the present invention.

FIG. 3 is a diagram of illustrative radio data system (RDS) information in accordance with an embodiment of the present invention.

FIG. 4 is front view of a display of a wireless electronic device showing an illustrative master playlist in accordance with an embodiment of the present invention.

FIG. 5 is a front view of a display of a wireless electronic device showing information for a selected alternate song in accordance with an embodiment of the present invention.

FIG. 6 is a front view of a display of a wireless electronic device showing an illustrative media management service screen providing a list of tagged songs for purchase in accordance with an embodiment of the present invention.

FIG. 7 is a front view of a display of a wireless electronic device showing illustrative radio settings that can be configured by a user in accordance with an embodiment of the present invention.

FIG. 8 is a flow chart of illustrative steps involved in setting up radio settings for a wireless electronic device in accordance with an embodiment of the present invention.

FIG. 9 is a flow chart of illustrative steps involved in operating a wireless electronic device to provide a master playlist based on user-selected radio settings in accordance with an embodiment of the present invention.

FIG. 10 is a flow chart of illustrative steps involved in running a media management service on a host computer to purchase previously tagged songs in accordance with an embodiment of the present invention.

FIG. 11 is a flow chart of illustrative steps involved in running a media management service on a wireless electronic device to purchase previously tagged songs in accordance with an embodiment of the present invention.

### DETAILED DESCRIPTION

The present invention relates generally to wireless communications, and more particularly, to managing a playlist in wireless electronic devices.

Wireless electronic devices that a user may use to receive radio stations may include electronic devices such as cellular telephones with radio tuners, media players with radio tuners, computers with radio tuners, etc. These are merely illustrative examples.

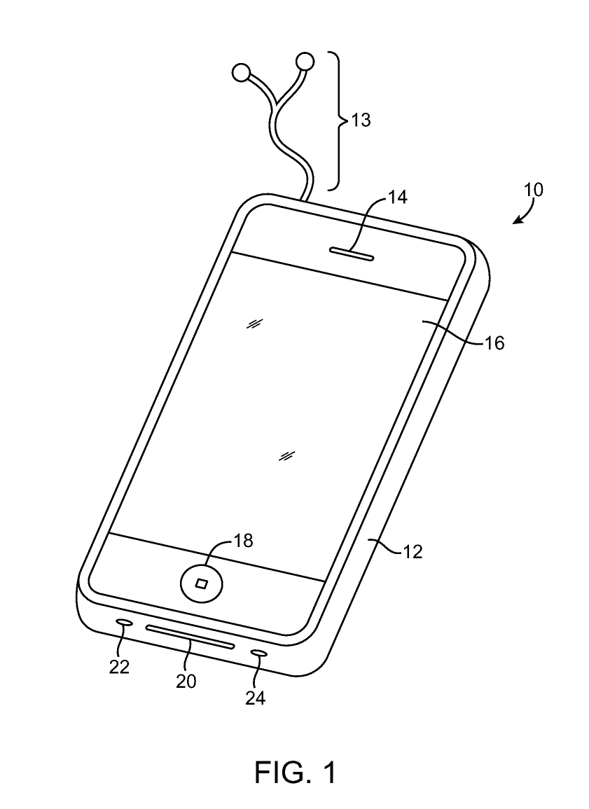

An illustrative wireless electronic device with radio tuning capabilities is shown in FIG. 1. Device 10 of FIG. 1 may be, for example, a handheld electronic device such as a cellular telephone or a media player. Device 10 may have housing 12. Antennas for handling wireless communications may be housed within housing 12 (as an example). An antenna for receiving radio stations (e.g., an FM antenna) may be provided in housing 12 or may be implemented as part of accessory 13 (e.g., as a ground wire in a pair of earbuds).

Housing 12, which is sometimes referred to as a case, may be formed of any suitable materials including, plastic, glass, ceramics, metal, or other suitable materials, or a combination of these materials.

Display 16 may be a liquid crystal diode (LCD) display, an organic light emitting diode (OLED) display, or any other suitable display. The outermost surface of display 16 may be formed from one or more plastic or glass layers. If desired, touch screen functionality may be integrated into display 16 or may be provided using a separate touch pad device. An advantage of integrating a touch screen into display 16 to make display 16 touch sensitive is that this type of arrangement can save space and reduce visual clutter.

Display screen 16 (e.g., a touch screen) is merely one example of an input-output device that may be used with electronic device 10. If desired, electronic device 10 may have other input-output devices. For example, electronic device 10 may have user input control devices such as button 18, and input-output components such as port 20 and one or more input-output jacks (e.g., for audio and/or video). Button 18 may be, for example, a menu button. Port 20 may contain a 30-pin data connector (as an example). Openings 24 and 22 may, if desired, form microphone and speaker ports. Opening 14 may form another speaker port.

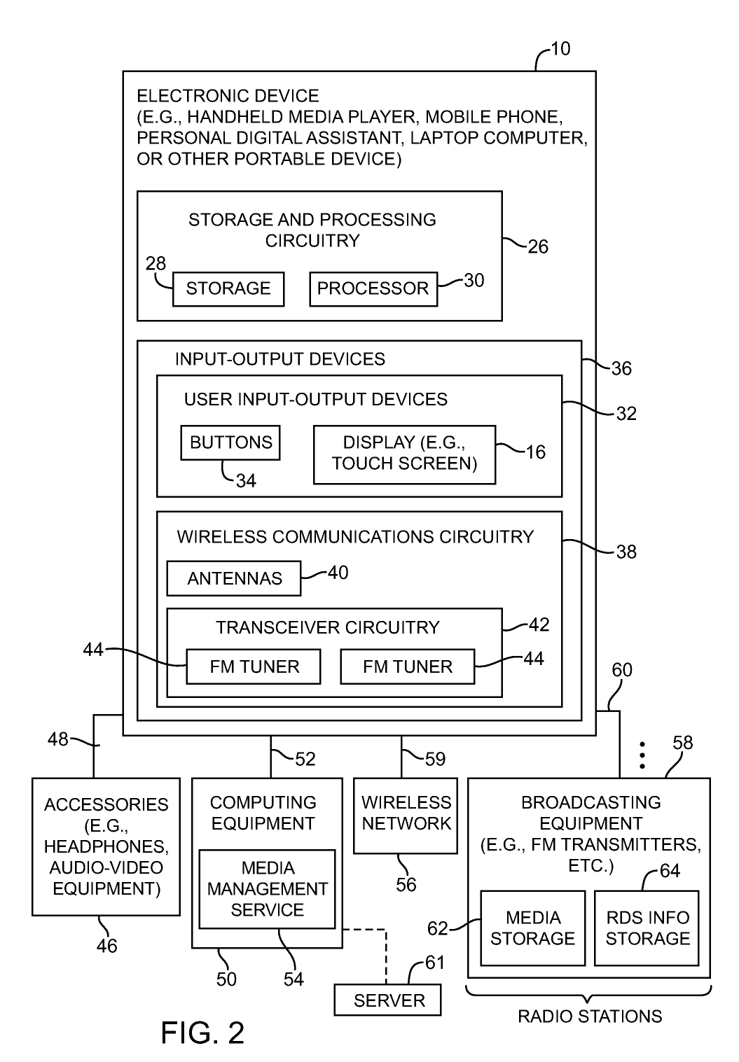

A schematic diagram of a system in which electronic device 10 of FIG. 1 may be used is shown in FIG. 2. As shown in FIG. 2, device 10 may include storage and processing circuitry such as storage and processing circuitry 26. Storage and processing circuitry 26 may include storage circuitry and processor circuitry such as storage circuitry 28 and processor 30. Storage circuitry 28 may include one or more different types of storage such as hard disk drive storage, nonvolatile memory (e.g., flash memory or other electrically-programmable-read-only memory), volatile memory (e.g., static or dynamic random-access-memory), etc. Processor 30 may be used to control the operation of device 10. Processor 30 may be based on a processor such as a microprocessor, a baseband processor, a digital signal processor, application specific integrated circuits, and other suitable circuitry. With one suitable arrangement, storage and processing circuitry 26 is used to run software on device 10, such as media management services, radio listening applications, internet browsing applications, media playback applications, operating system functions, etc.

Input-output devices 36 may be used to allow data to be supplied to device 10 and to allow data to be provided from device 10 to external devices. Input-output devices 36 can include user input-output devices 32 such as buttons 34 (e.g., menu button 18), display 16 (e.g., a touch screen), click wheels, scrolling wheels, touch pads, key pads, keyboards, microphones, cameras, etc. A user can control the operation of device 10 by supplying commands through user input-output devices 32. There may also be components in devices 36 that contain audio interface equipment such as jacks for external headphones.

Device 10 may also include wireless communications circuitry such as wireless communications circuitry 38. Wireless communications circuitry 38 may include circuitry such as antennas 40 (e.g., an FM antenna in housing 12 or an external antenna), radio-frequency (RF) transceiver circuitry 42, radio-frequency power amplifier circuitry, passive RF components, and other circuitry for handling RF wireless signals.

Transceiver circuitry 42 may include radio-frequency tuners such as FM tuners 44. FM tuners 44 may be used to tune to FM radio stations of interest. FM radio signals are transmitted by varying the frequency of a radio-frequency carrier signal. FM tuners 44 may be used to selectively receive radio-frequency signals broadcast from particular FM radio stations. If desired, transceiver circuitry 42 may include other types of radio-frequency tuners such as amplitude modulation (AM) tuners. In contrast to FM tuners, AM tuners are designed to receive AM radio-frequency signals (e.g., signals that are transmitted by varying the amplitude of a carrier wave) that are broadcast from AM radio stations. Both analog and digital radio stations may be received using tuners 44. If desired, tuners 44 may also be used to tune to other desired broadcast radio-frequency signals.

Device 10 can communicate with external devices such as accessories 46, computing equipment 50, wireless network 56, and broadcasting equipment 58 as shown by paths 48, 52, 59, and 60. Paths 48 and 52 may include wired and wireless paths. Paths 59 and 60 may be wireless paths. Accessories 46 may include headphones (e.g., a wireless cellular headset or audio headphones), audio equipment (e.g., wireless speakers or other equipment that receives and plays audio content), etc.

Computing equipment 50 may be any suitable computer. With one suitable arrangement, computing equipment 50 is a computer that has an associated wireless access point (router) or an internal or external wireless card that establishes a wireless connection with device 10. The computer may be a server (e.g., an internet server), a local area network computer with or without internet access, a user's own personal computer, a peer device (e.g., another portable electronic device 10), or any other suitable computing equipment. Computing equipment 50 may, for example, include a client application that implements functions for a service such as media management service 54. Media management service 54 may be launched on computing equipment 54 when device 10 is connected or docked to computing equipment 50. A remote server such as server 61 may be used in implementing functions for media management service 54.

Wireless network 56 may include any suitable network equipment, such as cellular telephone base stations, cellular towers, wireless data networks, computers associated with wireless networks, etc.

Broadcasting equipment 58 may be any suitable type of radio broadcasting equipment such as FM radio-frequency transmitters, AM radio-frequency transmitters, etc. Broadcasting equipment 58 may be used at multiple radio stations to transmit signals at desired frequencies. Each FM radio station may transmit signals at a different frequency in a very high frequency (VHF) range of 76 MHz to 108 MHz.

Broadcasting equipment 58 may also include media storage such as media storage 62. Media storage 62 may be a used as a database to store songs that radio stations may want to broadcast. Broadcasting equipment 58 may also have radio data system (RDS) information storage 64 that stores RDS data linked to each song in media storage 62.

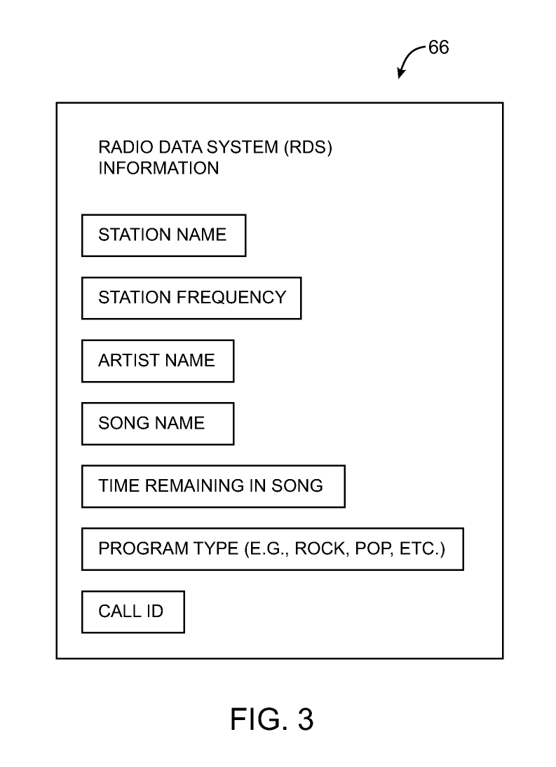

Radio data system data 64 preferably complies with the RDS communications protocol. This protocol is typically used by FM radio stations to broadcast a small amount of digital information in association with each broadcast song. As shown in FIG. 3, the RDS information that is broadcast in conjunction with a broadcast song may include information such as a station name for the broadcasting station, station frequency, artist name for the broadcast song, song name, time remaining in song, program type (e.g., song genre), and call identifier (ID) such as the station's call letters. For example, consider a scenario in which a user tunes device 10 to 107.7 MHz (FM). The user may know what song is currently playing on that radio station, because the user is currently listening to that radio station through a headphone connected to device 10 (as an example).

While device 10 receiving audio information for the song from 107.7, device 10 may also receive associated RDS information. For example, device 10 may also be able to determine that the station name of 107.7 FM is “The Bone,” that the artist name of the currently playing song is Bon Jovi, that the song name of the currently playing song is “Living on a Prayer,” that the time remaining in the currently playing song is two minutes and 43 seconds, that the program type is classic rock, and that the call ID of the current station is KSAN.

RDS information regarding the program type may be particularly useful. Each station may broadcast a program type (PTY) code that indicates the genre of music it generally broadcasts. There is a standard table of PTY code that all the radio stations abide by. For example, a radio station broadcasting pop music will include a PTY code of “10” in its RDS data 66 while a radio station broadcasting country music will include a PTY code of “25” in its RDS data 66.

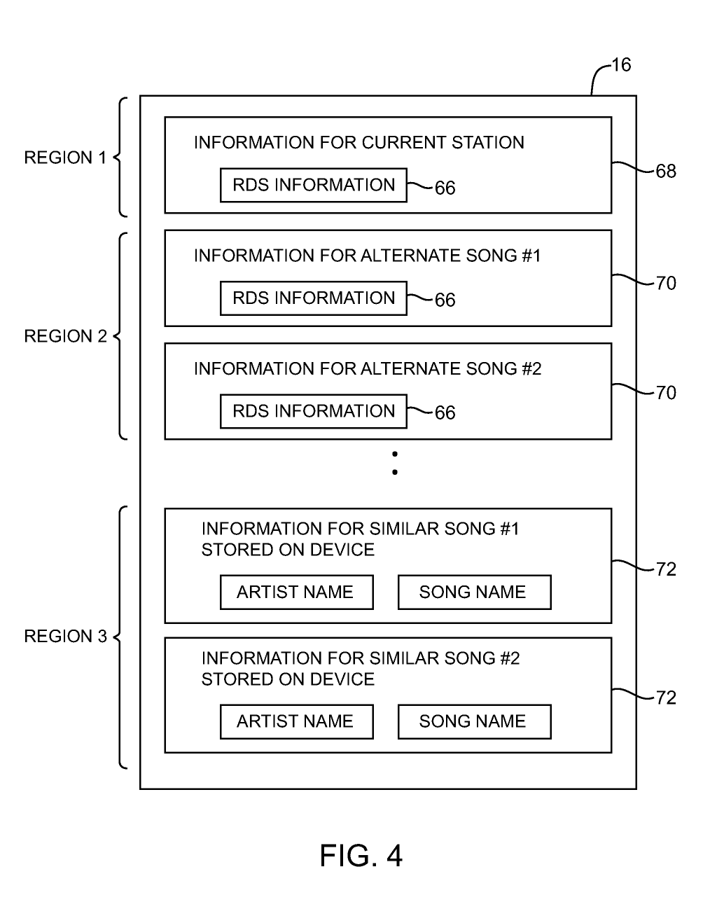

RDS information 66 may be used in compiling a playlist of relevant currently playing songs. The playlist of currently playing songs may sometimes be referred to as a master playlist. FIG. 4 is a front view of display 16 showing an illustrative master playlist. In a first region such as region 1, information for current station 68 may be displayed. The current station may refer to the radio station that device 10 is currently tuned to. Information for current station 68 may include RDS information 66 associated with the song playing on the current radio station. The RDS information may include items such as station frequency, station name, artist name, and/or song name for the currently playing song. This information may be displayed in region 1, if desired. Device 10 may be tuned to the current station using a first FM tuner in tuners 44.

At the same time that the first FM tuner is being used to receive audio and RDS data for a broadcast song, device 10 may scan the airwaves for other radio stations using a second FM tuner in tuners 44. The second FM tuner may acquire a list of RDS information from other available local radio stations. Storage and processing circuitry 26 may constantly update a list of acquired RDS information. The list of RDS information may represent a list of available content on available radio stations. If desired, a single tuner may be used to gather RDS data (e.g., to present a list of alternative stations). Single-tuner arrangements may, for example, cache RDS data in memory until needed.

The list of available radio stations may be filtered based on user-supplied and default filter criteria. For example, the list may be filtered to filter out radio stations that are not currently playing any songs and thereby produce a list of radio stations that are currently playing songs. The list of remaining radio stations may be further filtered according to desired user preferences. User settings may specify favored and disfavored genres (as an example). The final list of remaining radio stations may reflect a list of alternate songs that are currently playing on other radio stations and that may appeal to the users.

The list of alternate songs may be displayed in a second region such as region 2 that is adjacent to region 1 on display 16. The list of alternate songs may include a list of entries 70 that contain information for alternate songs. Entries 70 may be listed in a random or sorted order in region 2. Each entry 70 may include RDS information 66. Only two alternative songs are shown in the example of FIG. 4, but, in general, any desired number of songs may be displayed in region 2. If desired, the user may be provided with an option to change the number of alternate songs that are being displayed.

Device 10 may also have its own collection of songs stored internally on storage circuitry 28. Storage and processing circuitry 26 may analyze tag information in this collection to generate a list of songs that are similar to the song currently playing on the current radio station (e.g., songs in the same genre). The list of similar songs may include a list of entries 72 that contain the titles and other information for similar songs. Entries 72 may be listed in a random or sorted order in a third region such as region 3 that is adjacent to region 2 on display 16. Each entry 72 may include data such as the artist name, the song name, etc. The number of similar songs that is displayed may be adjusted based on user-supplied preferences.

A user viewing the master playlist of the type described in connection with FIG. 4 may be provided with an opportunity to select a song from the list of alternate songs (e.g., from region 2). For example, a user may want to view more information regarding alternate song #2. The user may select the corresponding region on display 16 (e.g., by touching a region of the surface of a touch screen) to select song #2.

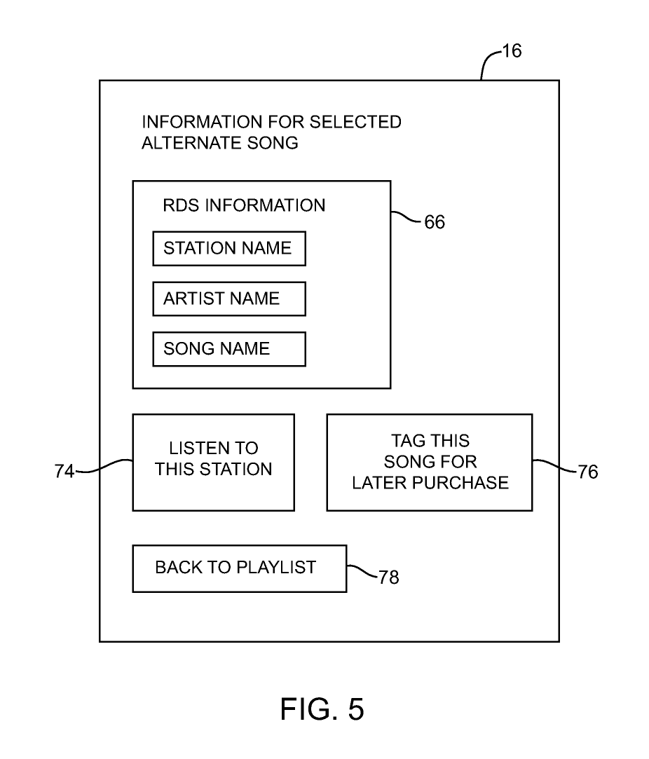

Appropriate action may be taken in response to a user's song selection. For example, selection of a song from the alternate song list may direct device 10 to display information for the selected alternate song, as shown in FIG. 5. This screen may include a complete list of RDS information associated with the selected song. If desired, RDS information may be displayed for the next song in the queue. If the user sees a song of interest, the user may listen to desired radio station by pressing button 74.

The user may be presented with an opportunity to tag a selected alternate song for later purchase (e.g., by pressing button 76). Once tagged, the RDS information of the tagged song may be stored in storage circuitry 28 for later processing (e.g., when device 10 is connected to computing equipment 50 of FIG. 3). If the user does not press button 74 to switch to a new radio station, the user may press button 78 to return to the master playlist.

When a user selects entry 70 in region 2, it may also be possible that device 10 automatically tunes to a new radio station to play a new song corresponding to the selected entry. For example, consider a scenario in which device 10 is currently playing Jason Mraz's “I'm Yours.” An alternate song list displayed in region 2 of device 10 may display Colbie Caillat's “Bubbly” and other alternate songs. A user of device 10 may touch a region on the display (e.g., a touch screen) of device 10 corresponding to the region that is displaying information for Colbie Caillat's “Bubbly.” Upon detecting the user's selection, device 10 may switch to a new radio station playing Colbie Caillat's “Bubbly.” The selected alternate song (e.g., Colbie Caillat's “Bubbly”) may replace the current song (e.g., Jason Mraz's “I'm Yours”) as the new current song that is displayed in region 1. While tuned to the new radio station, device 10 may present the user with an opportunity to tag the new song for later purchase.

If desired, a user can launch an application on device 10 for a media management service. The media management service may provide a medium through which music, games, applications and other items may be purchased or downloaded. The service may, for example, include the functions of the iTunes® digital media player application of Apple Inc. of Cupertino, Calif.

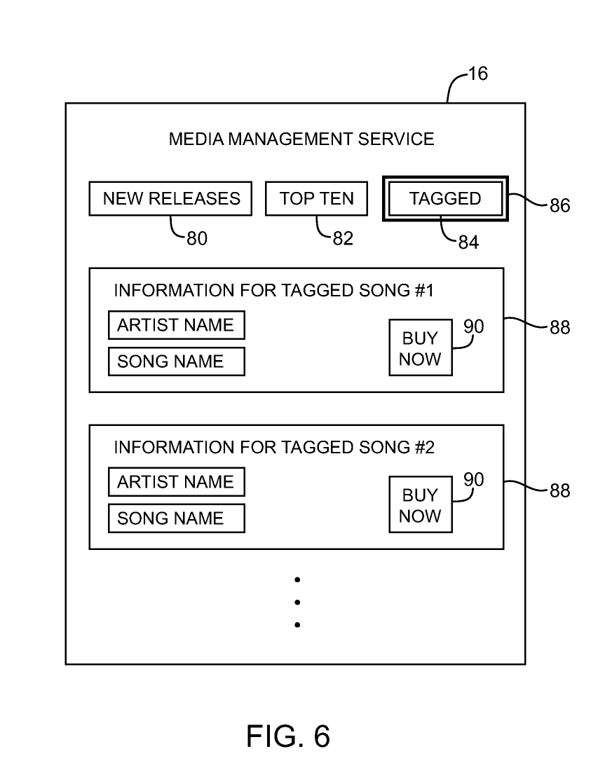

When launched, the media management service is displayed onto display 16, as shown in FIG. 6. There may be multiple tabs on the display. The tabs may include new release tab 80, top ten tab 82, or tagged tab 84. Other tabs may be displayed, if desired. A user may view a list of tagged songs by selecting tagged tab 84 to highlight tab 84, as shown by highlight box 86. Once selected, the list of tagged songs may be displayed. The list of tagged songs may include a list of entries 88. Each entry 88 may include information for each of the respective tagged songs and may include a buy now button such as button 90 that allows the user to purchase a song through the media management service. Once purchased, the song may be downloaded and stored into storage circuitry 28. Songs that are stored in the storage of device 10 may be added to an internal playlist. Songs on the internal playlist may be recommended and played at any time (e.g., the song does not need to be playing on any of the radio stations).

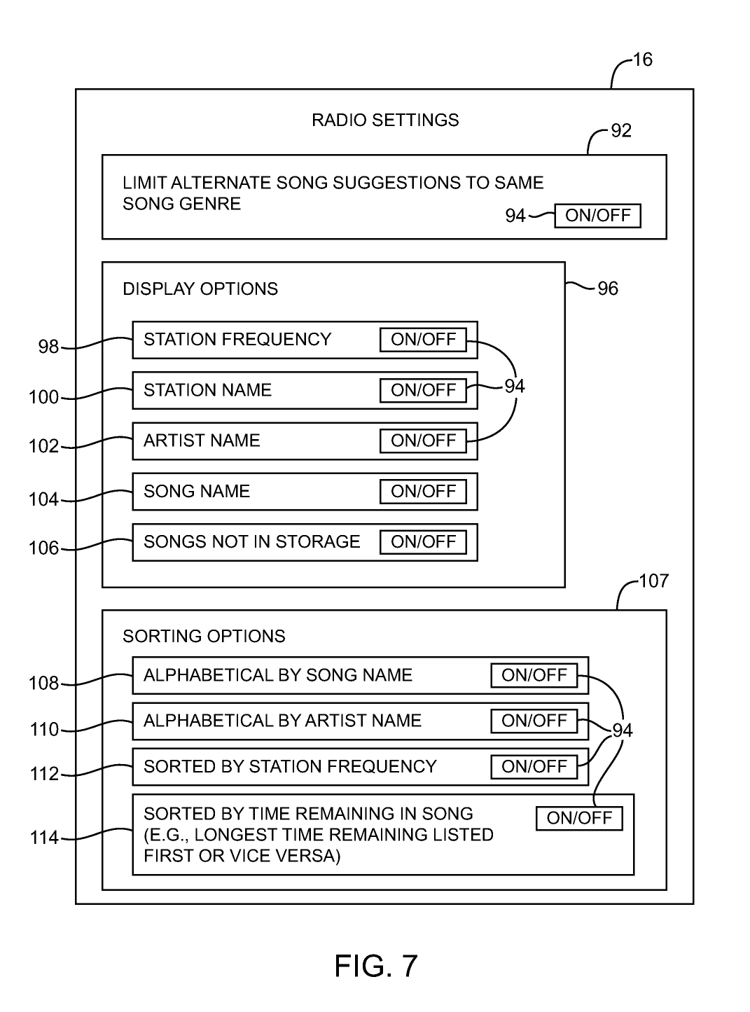

The master playlist may be configured based on user preferences. A user may be provided with adjustable radio settings, as shown in FIG. 7. FIG. 7 is a front view of display 16 of an electronic device showing illustrative radio settings that may be configured by a user. The user has the option of limiting the alternate song suggestions to songs of the same genre (option 92). On-off button 94 may be used to enable or disable this feature. For example, consider a scenario in which a user is current listening to Led Zeppelin's “Stairway to Heaven.” If the same song genre feature is enabled, the alternate song list displayed in region 2 may only display rock songs. This may be achieved by filtering the compiled list of RDS information according to the program type.

For example, a second FM tuner in the device may be used to scan other radio stations to obtain a complete list of songs currently playing on the other radio stations. The complete list of songs may include Tchaikovsky's “Piano Concerto No. 1,” Foghat's “Slow Ride,” LeAnn Rimes' “How do I Live,” Backstreet Boys' “I Want It That Way,” Muse's “Knights of Cydonia,” and other songs. The radio station broadcasting Tchaikovsky's “Piano Concerto No. 1” may include a program type (PTY) code of “14” in its RDS data (e.g., indicating that this station is broadcasting classical music). The radio station broadcasting Foghat's “Slow Ride” may include a PTY code of “11” in its RDS data (e.g., indicating that this station is broadcasting rock music). The radio station broadcasting LeAnn Rimes' “How Do I Live” may include a PTY code of “25” in its RDS data (e.g., indicating that this station is broadcasting country music). The radio station broadcasting Backstreet Boys' “I Want It That Way” may include a PTY code of “10” in its RDS data (e.g., indicating that this station is broadcasting pop music). The radio station broadcasting Muse's “Knights of Cydonia” may include a PTY code of “11” in its RDS data (e.g., indicating that this station is broadcasting rock music).

If the same song genre feature is turned on, the complete list of songs may be filtered according to the program type (i.e., the PTY code). The current song in this example is Led Zeppelin's “Stairway to Heaven.” The current song may have a PTY code of “11” corresponding to rock music. Only songs with a PTY code of “11” may be displayed in region 2 as an alternate song. Foghat's “Slow Ride” and Muse's “Knights of Cydonia,” for example, may be displayed as alternate songs, because both songs have a PTY code of “11.” The other songs with different PTY codes may be filtered out.

A user may disable the same song genre feature, if desired. In such scenario, all songs (e.g., Tchaikovsky's “Piano Concerto No. 1,” Foghat's “Slow Ride,” LeAnn Rimes' “How do I Live,” Backstreet Boys' “I Want It That Way,” and Muse's “Knights of Cydonia”) may be displayed as alternate songs in region 2 regardless of their PTY codes.

In another suitable arrangement, there may also be a similar song genre feature that is provided as an option to a user. The similar song genre feature may filter songs based on PTY codes broadcast with the RDS data to provide a list of alternate songs. The list of alternate songs may not necessarily need to have exactly the same PTY codes as the PTY code of the current song playing on the current radio station. For example, consider a scenario in which the current station is playing a pop song (e.g., having a PTY code of “10”). Rock music and country music may be deemed as similar genres to pop music (as an example). If the similar song genre feature is enabled, the alternate song list displayed in region 2 may display not only songs having PTY codes of “10,” but also songs having PTY codes of “11” (e.g., corresponding to rock music) and/or “25” (e.g., corresponding to country music).

The user may also be provided with an opportunity to adjust display options 96. Display options 96 affect the information that is displayed in region 2. For example, the user may be able to decide whether station frequency, station name, artist name, and song name is to be displayed by enabling or disabling options 98, 100, 102, and 104, respectively. A user may not desire to display alternate songs that are already in its internal playlist. The presentation of these internal songs may be blocked from region 2 by enabling option 106. If desired, alternate songs that are already in the playlist may be displayed in the similar song list in region 3.

The user may also be presented with an opportunity to adjust sorting options such as sorting options 107. Sorting options 107 may affect the order of information that is displayed in regions 2 and 3. For example, the songs may be arranged alphabetically by song name or artist name (options 108 or 110). The songs may also be arranged according to station frequency (option 112). If desired, the songs may also be arranged according to the time remaining in each song. For region 2, the song with the longest time remaining may be listed first while the song with the second longest time remaining may be listed second, and so on in descending order (as an example). Options 112 and 114 may not be applicable to songs listed in region 3.

The options described in connection with FIG. 7 are merely illustrative. Any suitable option can be incorporated into the radio settings screen. For example, additional display options may be presented that limiting the number of songs that are listed in regions 2 and/or 3. Every option may be enabled or disabled by respective on-off buttons 94 associated with each option or may otherwise be adjusted.

Device 10 may be initialized to a set of default radio settings. For example, the default settings may turn on option 92, may enable all display options 96, and may enable only option 108 as the preferred sorting method. The user need not adjust the radio settings if the default settings are acceptable to the user.

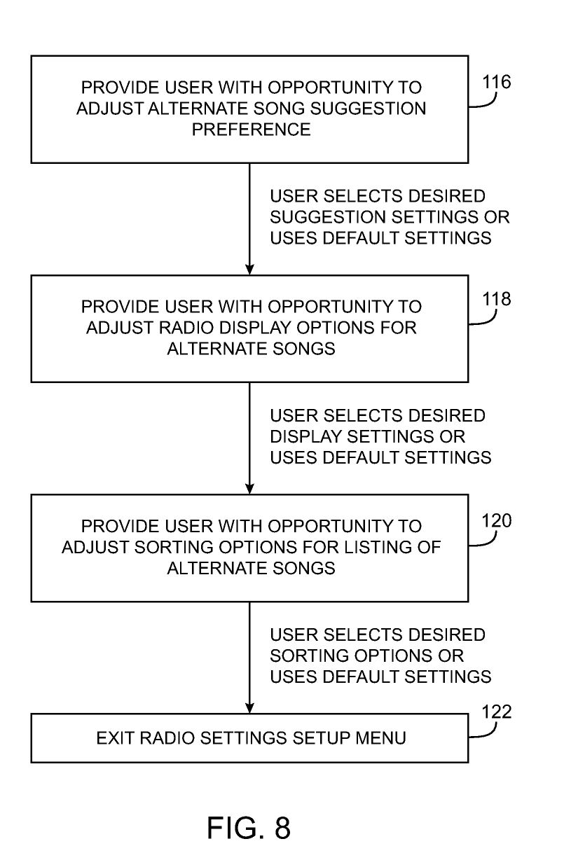

FIG. 8 shows illustrative steps involved in setting up device 10. At step 116, device 10 may provide a user with an opportunity to adjust alternate song suggestion preferences (e.g., allowing the user to enable or disable option 92). The user may select a desired alternate song suggestion setting or may use a default setting. At step 118, the user may be provided with an opportunity to adjust radio display options (e.g., by allowing the user to adjust display options 96). The user may select desired display settings or may simply use the default settings.

At step 120, device 10 may provide the user with an opportunity to adjust sorting options for listing the alternate songs (e.g., by allowing the user to adjust sorting options 107). The user may select desired sorting options or may use a default setting. Device 10 may exit the radio settings menu when the user has completed inputting desired preferences (step 122).

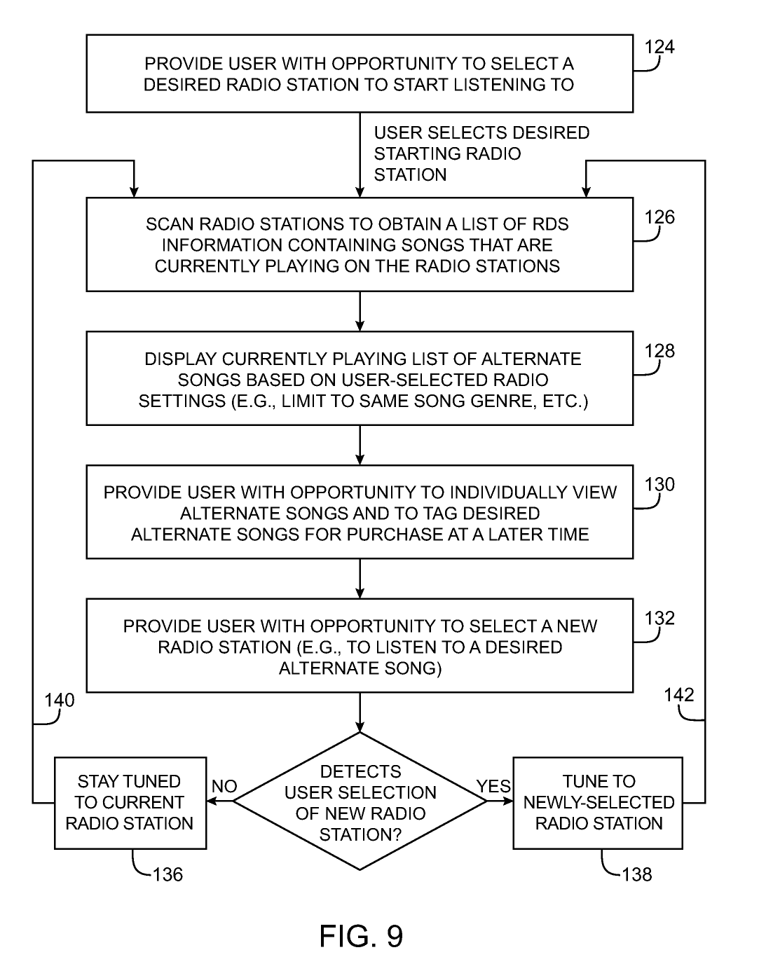

Device 10 may be operated by a user to listen to songs broadcast over the radio, as shown in the flow chart of FIG. 9. At step 124, device 10 may provide the user with an opportunity to select a desired radio station (e.g., an initial radio station to start listening to). The user may pick the initial radio station based on a favorite list of radio stations or based on recently selected radio stations. Device 10 may use a first FM tuner to tune to the initial radio station.

Without disrupting the current station that is being received by the first tuner, device 10 may use a second FM tuner to scan other radio stations. At each available station, the second tuner may obtain a list of RDS information (step 126). The list of RDS information may contain a list of alternate songs currently playing on the other radio stations. At step 128, the list of alternate songs may be displayed on screen 16 in a configuration that is based on the user-selected and default radio settings configured during steps 116, 118, and 120.

For example, a user may be currently listening to a radio station playing Taylor Swift's “Love Story.” Information regarding the radio station playing Taylor Swift's “Love Story” may be displayed in a region on the display of device 10. The list of alternate songs may include Carrie Underwood's “Before He Cheats,” David Cook's “Come Back to Me,” Katy Perry's “Hot N Cold,” and other similar songs. The songs in the list of alternate songs may each belong to the same or similar genre as Taylor Swift's “Love Story.” Each entry 70 containing information of an alternate song may display a corresponding station name and station frequency in addition to the artist and song names. The list of alternate songs may be sorted alphabetically by artist name (as an example).

The user may subsequently be provided with an opportunity to individually view (select) any one of the alternate songs and to tag the selected alternate song so that the song can be purchased at a later time (step 130). At step 132, device 10 may provide the user with an opportunity to select a new radio station while viewing the selected alternate song. If device 10 does not detect that the user has chosen to listen to the new radio station, device 10 may stay tuned to the current radio station (step 136). The process may then loop back to step 126, as indicated by path 140.

If device 10 detects that the user has selected an option to listen to a new radio station, device 10 may tune the first FM tuner to the newly-selected radio station (step 138). Processing may then loop back to step 126, as indicated by path 142.

Steps 130 and 132 may be bypassed, if desired. A user making any alternate selection (e.g., by selecting an alternate song from region 2 or a similar song from region 3) on the master playlist may automatically direct device 10 to play the selected song. In the scenario in which an alternate song from region 2 is selected, device 10 may tune to a new radio station to play the selected alternate song. In the scenario in which a similar song region 3 is selected, device 10 may play the selected similar song directly from an internal playlist of the device. A user may be presented with an opportunity to tag the newly selected alternate song (i.e., playing from a radio station) for later purchase once the device is playing the newly selected song.

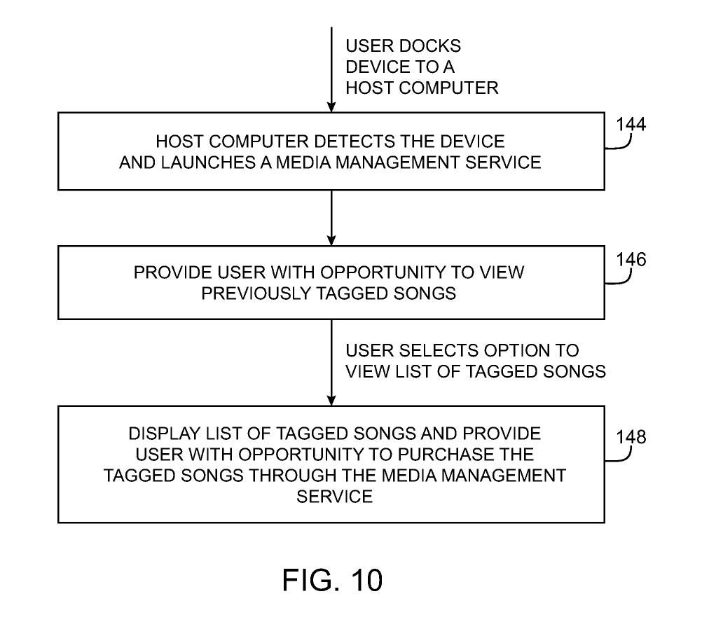

Device 10 may be docked at any time, as shown in FIG. 10. In response to a user docking device 10 to a host computer, the host computer may launch a media management service (step 144). The host computer may be a personal computer such as computing equipment 50 of FIG. 2, as an example. The host computer may be connected to the Internet through a wired or wireless network. Online portions of the media management service may then be provided to device 10 from server 61 over the Internet. At step 146, the media management service may provide the user with an opportunity to view a list of previously tagged songs. The user may choose to view the list of previously tagged songs. At step 148, device 10 may display the list of previously tagged songs on the monitor of computer 50 and may provide the user with an on-screen option or other opportunity to purchase the tagged songs through the media management service and to download the purchased songs from server 61 to device 10 over the Internet.

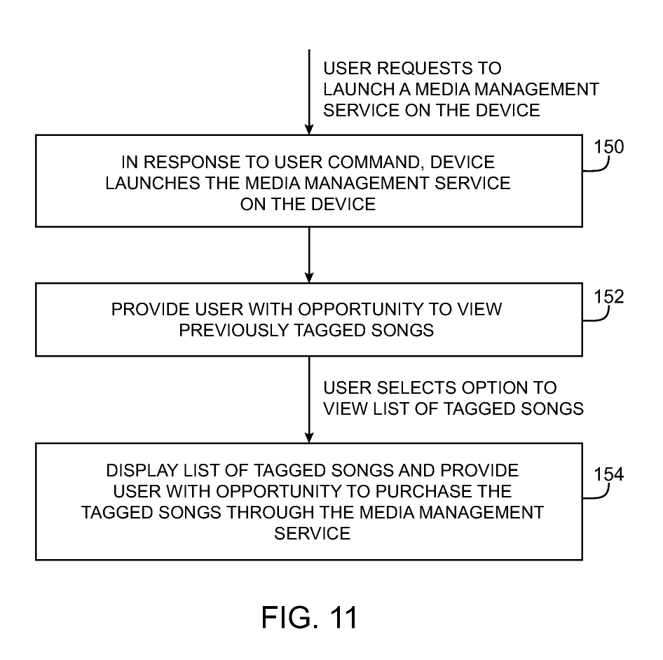

The media management service may also be launched directly on device 10, as shown in FIG. 11. In response to a user request, for example, device 10 may launch the media management service on the device (step 150). Because the media management service has an online service component, device 10 may be connected to the Internet and server 61 using any suitable wireless communications protocol such as WiFi®, as an example. At step 152, device 10 may provide the user with an opportunity to view the list of previously tagged songs (e.g., on display 16). The user may choose to view the list of previously tagged songs. At step 154, device 10 may display the list of tagged songs and may provide the user with an opportunity to purchase any song from the list of tagged songs through the media management service.

The foregoing is merely illustrative of the principles of this invention and various modifications can be made by those skilled in the art without departing from the scope and spirit of the invention.

What is claimed is:

1. A handheld electronic device, comprising:
a first frequency modulation (FM) tuner that receives a given broadcast FM radio station;
a second FM tuner; and
storage and processing circuitry that is configured to use the second FM tuner to receive radio data system (RDS) data for currently playing songs on other broadcast FM radio stations while the first FM tuner is receiving the given broadcast FM radio station.

2. The handheld electronic device defined in claim 1, further comprising:
a display on which a list of the currently playing songs on the other broadcast FM radio stations is displayed.

3. The handheld electronic device defined in claim 2, wherein the display comprises a touch screen on which a user supplies input commands that select a desired song from the list of currently playing songs.

4. The handheld electronic device defined in claim 1, further comprising:
cellular telephone transceiver circuitry that wirelessly transmits and receive cellular telephone calls.

5. A method of operating a portable electronic device with frequency modulation (FM) radio station tuners that can be tuned to receive FM radio station broadcasts, wherein each of the FM radio station broadcasts is accompanied by wirelessly transmitted radio data system (RDS) data reflecting which content is currently being carried by that FM radio station broadcast, comprising:
tuning to a given FM radio station with a first tuner in the portable electronic device;
while tuned to the given FM radio station, using the first tuner to receive audio for a given song over the given FM radio station; and
while tuned to the given FM radio station and while using the first tuner to receive the audio for the given song, gathering the RDS data for each of a plurality of other FM radio stations by tuning to each of the plurality of other FM radio stations with a second tuner in the portable electronic device.

6. The method defined in claim 5, further comprising:
displaying at least part of the RDS data gathered from the plurality of other FM radio stations while tuned to the given FM radio station and while using the first tuner to receive the audio for the given song.

7. The method defined in claim 6, wherein the RDS data gathered from the plurality of other FM radio stations includes titles for songs currently being broadcast on each of the plurality of other FM radio stations and wherein displaying the RDS data comprises displaying a list of the titles.

8. The method defined in claim 7, further comprising displaying the title of the given song while simultaneously displaying the list of titles of the songs currently being broadcast on each of the plurality of other FM radio stations, wherein each of the titles in the list of titles of the songs currently being broadcast on each of the plurality of other FM radio stations is associated with an on-screen option that can be selected to tune the first tuner to the other FM radio station that is currently broadcasting the song corresponding to that title.

9. The method defined in claim 6, wherein displaying the RDS data comprises displaying a list of alternative currently broadcast songs that may be received by tuning the first tuner.

10. The method defined in claim 9, further comprising:
while tuned to the given FM radio station, receiving a RDS program type corresponding to the given song indicative of a song genre for the given song.

11. The method defined in claim 10, wherein displaying the list of alternative currently broadcast songs comprises:
displaying a list of song choices that only contains alternative currently broadcast songs that match the song genre for the given song.

12. The method defined in claim 9, further comprising:
with the portable electronic device, receiving input from a user to tag at least one of the alternative currently broadcast songs for purchase.

13. A method for operating a handheld electronic device with first and second broadcast radio tuners, comprising:
with the first broadcast radio tuner, tuning to a given broadcast radio station; and
while tuned to the given broadcast radio station with the first broadcast radio tuner, scanning for other broadcast radio stations using the second broadcast radio tuner.

14. The method defined in claim 13 further comprising gathering radio data system (RDS) data for the given broadcast radio station with the first broadcast radio tuner while the first broadcast radio tuner is tuned to the given broadcast radio station.

15. The method defined in claim 14, further comprising gathering RDS data for the other broadcast radio stations using the second broadcast radio tuner while the first broadcast radio tuner is tuned to the given broadcast radio station.

16. The method defined in claim 15, further comprising:
simultaneously displaying at least part of the RDS data for the given broadcast radio station and at least part of the RDS data for the other broadcast radio stations on a display in the handheld electronic device.

17. The method defined in claim 16, further comprising:
providing a user of the handheld electronic device with an on-screen option that the user may select to tune to one of the other broadcast radio stations.

18. The method defined in claim 17, wherein providing the on-screen option comprises displaying a selectable option that includes information identifying that one of the other broadcast radio stations and identifying which song is currently being broadcast on that one of the other broadcast radio stations.

19. The method defined in claim 16, wherein the given broadcast radio station is broadcasting a song belonging to a given musical genre, the method further comprising:
displaying a list of similar songs on the display in the handheld electronic device, wherein the similar songs belong to musical genres that are substantially similar to the given musical genre and wherein the similar songs are stored on storage and processing circuitry located in the handheld electronic device.

20. The method defined in claim 19, further comprising:
providing the user of the handheld electronic device with an on-screen option that the user may select to play one of the similar songs.

21. A method of operating a handheld electronic device that receives frequency modulation (FM) radio stations, comprising:
displaying song title information associated with a given currently received FM radio station on a display in the handheld electronic device; and
while displaying the song title information for the given currently received FM radio station, displaying on the same display a list of user-selectable options to receive alternative currently available songs on other FM radio stations.

22. The method defined in claim 21 further comprising:
in response to user selection of one of the user-selectable options, automatically tuning the handheld electronic device to a corresponding one of the other FM radio stations to receive the alternative currently available song on that other FM radio station.

23. The method defined in claim 22 further comprising:
gathering the song title information for the list of user-selectable options while tuned to the given currently received FM radio station.

24. The method defined in claim 23 wherein gathering the song title information comprises receiving broadcast radio data system information.

25. The method defined in claim 21 further comprising:
providing the user with at least one option on the display that the user can select to tag a desired one of the alternative currently available songs for later purchase.
